(19) United States
(12) Patent Application Publication
(10) Pub. No.: US 2007/0174176 A1
(43) Pub. Date: Jul. 26, 2007

(54) Optimized order routing for electronic trading

(76) Inventor: Steven J. Brucato, Naperville, IL (US)

Correspondence Address: MICHAEL P. MAZZA, LLC, 686 CRESCENT BLVD., GLEN ELYN, IL, 60137, US

(21) Appl. No.: 11/336,204

(22) Filed: Jan. 21, 2006

(51) Int. Cl. G06Q 40/00

(52) U.S. Cl. 705/37

(57) ABSTRACT

A method for optimizing the rate at which an order-related message is received by an electronic market. Passive messages may be transmitted along different order routes from a user/trader to an electronic market. The fastest or most expeditious route may be calculated, and active messages may then be transmitted along this route. Active message times may then be calculated, and these times may be used to again calculate the fastest or most expeditious routes.

### BACKGROUND OF THE INVENTION

The disclosures of concurrently-filed U.S. Ser. No. ______ , titled “A Graphical User Interface And Method For Displaying Market Data And Entering Trading Orders,” concurrently-filed U.S. Ser. No. ______, titled “A Method For Indicating Current Market Prices Across A Range Of Prices,” concurrently-filed U.S. Ser. No. ______, titled “A Method For Estimating The Time Position Of Queued Electronic Orders,” U.S. Ser. No. ______, filed Dec. 21, 2005, titled “A Graphical User Interface And Method For Displaying Market Data And Entering Trading Orders,” U.S. Ser. No. ______, filed Dec. 6, 2005, titled “Method And System for Detecting And Managing Message Throttle Conditions,” and U.S. Pat. Nos. 6,938,011 and 6,772,132, are hereby incorporated by reference into this application in their entirety.

The present invention generally relates to computerized trading systems. More specifically, the invention relates to a method for optimizing electronic trading orders.

Trading of stocks, bonds, and derivatives (i.e., futures and options) has moved more and more into electronic trading. As more and more traders and trading firms have entered the market place, order volumes have risen dramatically and competition among traders and trading firms to achieve an advantage in trading by increasing the speed with which an order reaches the market has increased. In cases where there are, for example, multiple buy orders for the same buy price, these orders are often automatically queued by the electronic market in the order in which they were received. The first order submitted (in terms of time) is placed at the front of the queue, the next behind it, and so on. Most electronic markets employ some form of time priority in “matching” buy and sell orders to create a trade. A common match algorithm is the price-time match algorithm which matches orders on the basis of their price and the time they were received. Thus, orders at near the front of the time queue have an advantage in trading before other orders behind them in queue.

As many electronic markets use time queuing and time priority as a function of matching, it is valuable for a trader who desires to trade to have his order positioned as near the beginning of the time queue as possible. This requires transmitting the order to the electronic market engine, and having it received, as quickly as possible.

Accordingly, it would be advantageous to enable a trader to optimize the speed (e.g., by minimizing the averaged elapsed time) between the time an order is submitted to an electronic market and the time at which it is received by the electronic market, as well as optimizing the fill rate.

### SUMMARY OF THE INVENTION

The present invention enables a trader to optimize the speed between the time an order is submitted to an electronic market and the time at which it is received by the electronic market.

In a preferred embodiment, a method is provided for optimizing the rate at which an order-related message is received by an electronic market. One or more passive message may be transmitted along a plurality of order routes from the user/trader's transmitting device (e.g., a computer or PDA) to the electronic market engine. One-way message times are calculated for the one or more passive messages for at least some, or all, of the order routes. A preferred route, which may be but need not be the fastest route, for the one or more passive messages may then be calculated based on the calculated one-way message times, and active messages may then be transmitted along this route. Active message times may then be calculated and used for planning a new fastest or most expeditious route.

In a particularly preferred embodiment, the one-way message times are calculated by calculating a weighted average of the one-way message times for the one or more passive messages for at least the order routes as to which a one-way message time was calculated. Then, the preferred route is found by calculating the fastest or most advantageous route for the one or more passive messages based on the weighted average of one-way message times.

Other weighting factors, such as route dependability over time, fill rates or fill prices, in addition to weighting based on whether the message is most recent or not, may be used to determine the most expeditious and/or preferred order route.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic illustration of a typical method by which trading firms connect to an electronic market;

FIG. 2 consists of schematic diagrams showing buy and sell orders, all for the same buy price, queuing into a price level queue for that price;

FIG. 3 consists of schematic diagrams showing the matching of orders at the same price using a matching “price-time” algorithm; and

FIG. 4 consists of schematic illustrations of the process of calculating round trip message times, the first in which a submit order is sent (to add a new order in the market) and the second in which a query message is sent.

The components in the drawings are not necessarily to scale, emphasis instead being placed upon clearly illustrating the principles of the present invention. In the drawings, like reference numerals designate corresponding parts throughout the several views.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Active message” means a message relating to an order which changes the order in some way, such as an order submit, order delete or order revision.

“Electronic market engine” means the software application(s) which handles inbound order traffic and matches buyers with sellers based on a match algorithm.

“Fill rate” means the speed at which a particular order is filled.

“Fill price” means the average price for all fills for a particular order.

“Logical connection” means an individual user/trader session or data connection, typically preceded by a “log on” and username/password input, enabling a trader to communicate an order-related message between a trader transmitting device and an electronic market engine.

“Order-related message” means a message relating to an order, which may either constitute an active message or a passive message.

“Order route” means a specific route, which may include physical and/or logical connections, which an order-related message may take from a trader's transmitting device to an electronic market engine.

“Passive message” means a message relating to an order which does not enter an order into the market, does not change an order in the market, and will not create a possible trade. Included within “passive message” are messages not intended to produce a trade (e.g., a regular order given a limit price that is so far away from the current trading price in the market that it is intentioned that it not result in a trade, and that is typically canceled after submission to be sure it does not result in a trade).

“Physical connection” means an electrical circuit useful for connecting a trader's transmitting device to an electronic market engine, such as but not limited to a copper or fiber optic (e.g., Ti) line or Internet connections.

“PDA” means an electronic device capable of storing, transmitting and receiving trading orders, including but not limited to a cell phone, Blackberry, or other electronic personal assistance device;

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

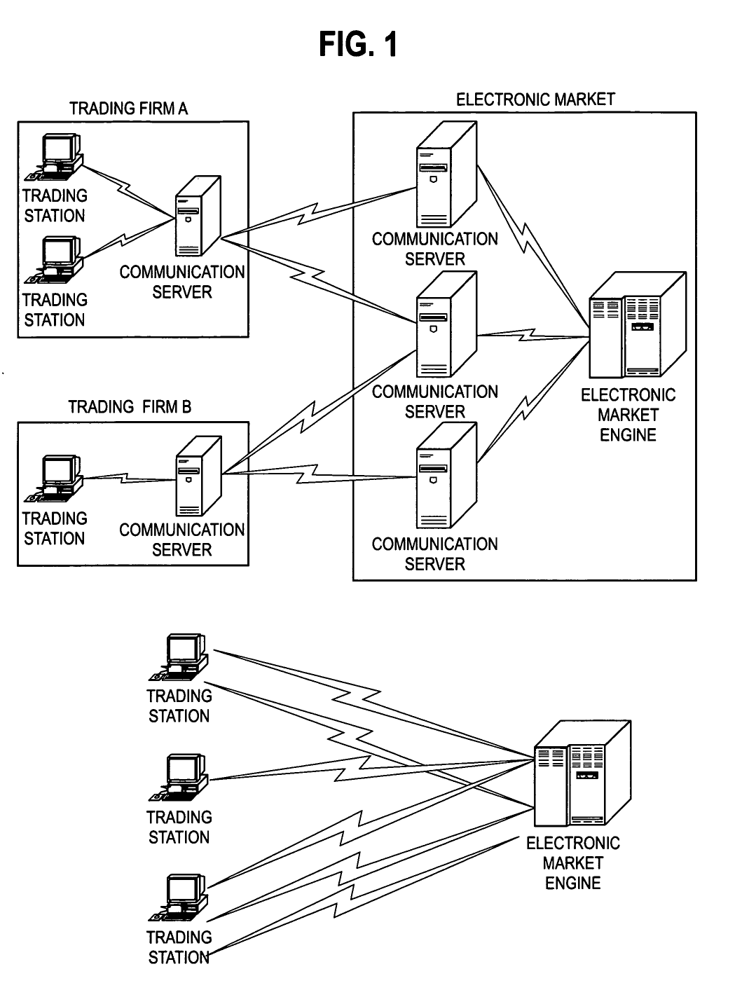

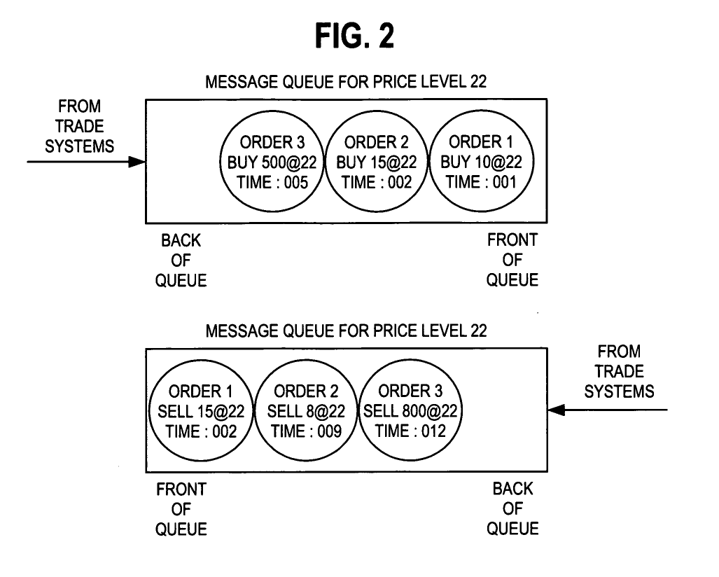

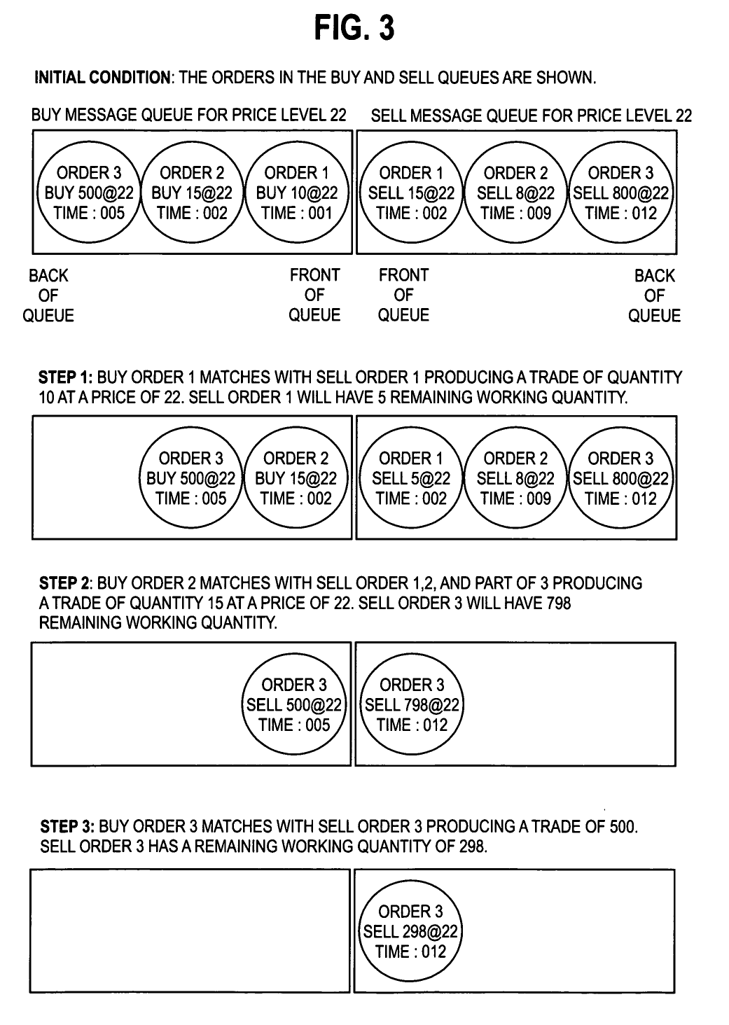

As backround, FIG. 1 shows a typical method by which trading firms connect to an electronic market. As FIG. 2 shows, in a typical electronic market the first order is positioned at the front of the queue, the second order is positioned behind it, and so on. FIG. 3 shows the matching of orders at the same price. In the particular example of FIG. 3, orders are matched using a matching algorithm of “price-time” which means that any opposing orders (buy and sells) at the same price level are matched in the order of their time position in queue.

Order Routes

As FIG. 1 shows, most electronic markets have some sort of communication layer in between the traders and the electronic market engine. The electronic market engine is a software application(s) which handles all inbound order traffic and matches buyers with sellers based on a match algorithm. The communication layer usually provides several functions including authentication (verifying the identity of the trader or trading firm to ensure that they have access rights), session management (managing the connection between the trader and the market), and pre-processing of messages sent to the market. As FIG. 1 shows, a given communication server can often service more than one trading firm (or trader). This means that the amount of message traffic being handled by any one communication server can vary. For example, trading firm B may be submitting orders at a very high rate and this would provide a disadvantage to trading firm A for orders which are submitted through the same communication server, which may be slowed in processing order due to the large volume of orders from Firm B. During such a time, it would be beneficial for trading firm A to be able to detect this situation and route the orders through an alternate communication server instead.

Most markets will allow a trader or trading firm to make multiple logical or physical connections. Physical connections may consist of private circuits such as T1 lines or Internet connections. Logical connections are also known as sessions. One physical connection can support many logical connections. It can be the case that each logical connection connects the trading firm to the electronic market via different communication servers. It may also be the case that each logical connection is connected via a different physical connection (i.e., via a different line). In all situations, as long as a trading firm can make multiple logical connections, regardless of how these are facilitated (via multiple physical connections or via a single physical connection), it is possible for that firm to have multiple different order routes into the electronic market.

The second, lower diagram in FIG. 1 shows a different connection scheme. In this scheme, each trading station makes one or more logical connections to the market. It is not necessary for a communication server to be in the message path for an order to have multiple routes to reach a market. So in general, whenever multiple logical connections exist between a trader and an electronic market, the possibility exists for optimizing the speed with which the order arrives at the market by finding the fastest route.

Although new orders (i.e., new order messages submitted to the market) have been specifically referenced here, the benefits of the present invention to the trader extend to all types of messages that are sent to the market. A trader may submit other types of messages such as a delete order message (to remove an order from the market) or a revise order message (to change one or more parameters of an order). Any message submitted by a trader to an electronic market may benefit from the present invention's fastest path message routing scheme.

Detecting the Fastest and/or Most Expeditious Route

Whenever multiple routes (paths) exist, it is possible to detect the fastest route by measuring the round trip message time for messages sent via each route. For example, by measuring the time between submitting an order and receiving an order response, the one-way message time for a given route may be calculated by halving the round trip time.

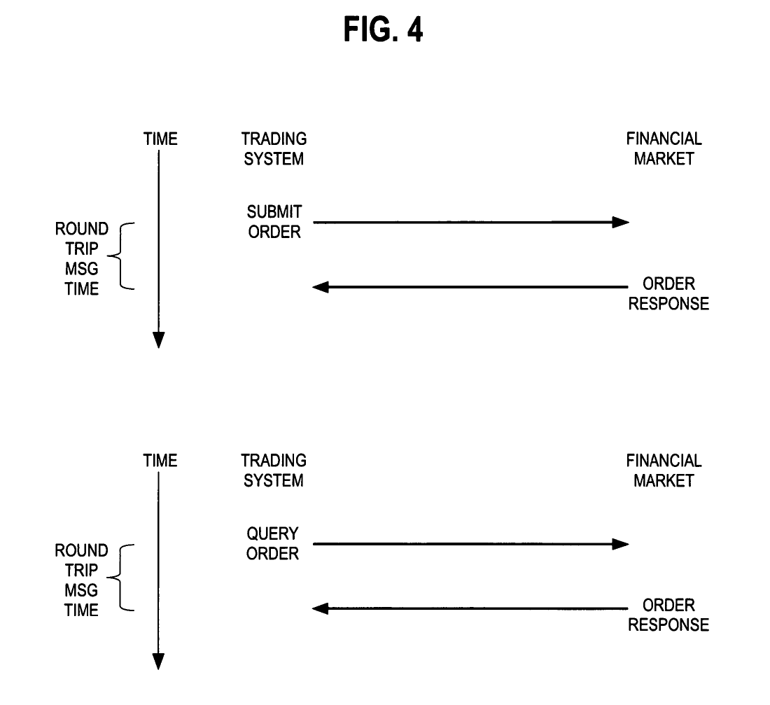

FIG. 4 illustrates the process of calculating a round trip message time. Two examples are shown, one in which a submit order is sent (to add a new order into the market) and another in which a query message is sent.

In a preferred embodiment of the present invention, route speeds may be calculated as follows. On a periodic basis, say once every 10 seconds or once every minute (this period may be configurable by the operator), a “passive” message may be sent down each of the many logical and/or physical routes from the trader to the market. A passive message is one which does not expose the trader to any risk by changing his working orders in any way. For example, a message that simply queries the status of an existing order is a good example of a passive message—it does not change the trader's trading strategy in any way (i.e., no changes to any working orders are made) but because it does illicit a response, the one-way message time may be calculated.

With each calculation of one-way message routing times for each of the logical and/or physical routes, a weighted average of the average one-way message times is calculated. The weighting vector is typically selected to more heavily weight the more recent measurements and less heavily weight older measurements. The algorithm to calculate the average can vary—any meaningful algorithm may be used. As a preferred, non-limiting example, a weighted average may be used that weighs more recently submitted one-way message times more heavily than older ones. So, for example, if a passive message is submitted every 10 seconds, the average of the last five one-way message times may be measured, yielding an average representing the average one-way message times over 50 seconds. A weighting vector (e.g., 3, 2, 1, ½, ⅓) may then be applied to give more influence to the more recent measurements, resulting in (e.g.) a weighted average of: (3*meas5 +2*meas4+1*meas3+½*meas2+⅓*meas1)/5. In this example, meas1 is the oldest measurement and meas5 is the most recent measurement of one-way message time. Again, other expeditious or advantageous algorithms may be used, such as simply selecting the most recent one-way measurements, or averaging the last two one-way measurements, etc. Once the resulting message time is calculated for each route, the fastest or most expeditious route may be determined based on the algorithm. (The fastest route may not be the most expeditious or “preferred” route to be selected, as the fastest route may have proven undependable or unreliable over recent history, for example.)

Thereafter, whenever the trade initiates an “active” message such as an order submit, order delete, or order revision, the order may then be routed through the fastest path per the above calculations. Each of these active messages may then be used, in turn, to calculate more recent one-way message times and to estimate the speed of that particular order route or path.

The most expeditious route may also depend on factors other than speed or dependability, such as the fill rate (the speed at which a particular order is filled) or fill price (the average price for all fills for a particular order). Thus, an algorithm may be designed to measure the likelihood of an order being filled at a preferred price. When a trader submits an order, the typical intent is to fill it at or better than the limit price (e.g., a limit order of “buy 10 at a price of 1000 or better” means the trader will pay less than and up to 1000 but not more). In this case, the algorithm may measure which of the logical links tend to produce the highest fill rate. The highest fill rate may be measured as a percentage of the original order quantity (e.g., 10 in the previous example) which actually gets filled (e.g., say 7 of the 10 are traded, aka filled) divided by the time elapsed from the time the order was submitted to the time the order was filled. In this example, the fill rate would be ( 7/10)/(elapsed time between time order was sent and last fill message received for this order). Faster speeds may result in better fill rates, so some traders may prefer to measure speed as opposed to fill rates, although this is not necessarily the case (particularly with position traders who are less concerned about speed than simply getting their trades filled). It must also be considered that not all traders really intend all of their orders to fill—some may use “spoof” orders that they want to cancel before they are filled or before they are completely filled, to measure/test certain aspects of the market.

Regarding fill price, and continuing with the prior example, if the trader submits an order for 10, he/she may get several partial fills: (e.g.) 7 at a price of 1000, 1 at a price of 990, and 2 at a price of 980. In this case, the average fill price would be: (7*1000+1*990+2*980)/10. The average fill price for a particular logical connection could be measured and, at that point, optimize the path that generates the optimum fill price (i.e. lowest buy price, highest sell price).

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. A method for optimizing the rate at which an order-related message is received by an electronic market, comprising the steps of:
transmitting one or more passive message along a plurality of order routes from the trader's transmitting device to the electronic market engine;
calculating a one-way message time for the one or more passive messages for at least some of the order routes;
calculating one-way message times for the one or more passive messages for at least the order routes as to which a one-way message time was calculated; and
calculating a preferred route for the one or more passive messages based on the calculated one-way message times.

2. The method of claim 1, wherein the step of calculating one-way message times comprises calculating a weighted average of one-way message times for the one or more passive messages for at least the order routes as to which a one-way message time was calculated, and wherein the step of calculating a preferred route comprises calculating the fastest route for the one or more passive messages based on the weighted average of one-way message times.

3. The method of claim 1, wherein the step of calculating one-way message times for the one or more passive messages is accomplished as to each of the order routes.

4. The method of claim 3, wherein the step of calculating a weighted average of one-way message times for the one or more passive messages is accomplished by including the calculated one-way message times as to each of the order routes.

5. The method of claim 1, further comprising the step of transmitting active messages using the fastest route calculated for the one or more passive messages.

6. The method of claim 5, further comprising the step of calculating one-way message times for the active messages, and using these calculations to estimate the speed of the order routes.

7. The method of claim 1, wherein the trader's transmitting device comprises one or more of the following: a computer or a PDA.

8. The method of claim 5, further comprising the step of calculating one-way message times for the active messages and using these calculations to calculate more recent one-way message times and again determine a preferred route.

9. The method of claim 1, wherein the preferred route is determined at least based on a calculated fill rate.

10. The method of claim 1, wherein the preferred route is determined at least based on a calculated fill price.
